(19) United States
(12) Patent Application Publication
(10) Pub. No.: US 2009/0142562 A1
(43) Pub. Date: Jun. 4, 2009

(54) ANTISTATIC ANTI-GLARE FILM

(76) Inventors: Sachiko Miyagawa, Tokyo (JP); Seiji Shinohara, Tokyo (JP)

Correspondence Address: LADAS & PARRY LLP, 224 SOUTH MICHIGAN AVENUE, SUITE 1600, CHICAGO, IL, 60604, US

(21) Appl. No.: 12/064,140

(22) PCT Filed: Aug. 11, 2006
(86) PCT No.: PCT/JP2006/315934

§ 371 Date: Jun. 9, 2008

(30) Foreign Application Priority Data
Sep. 16, 2005 (JP) 2005-270457

(51) Int. Cl. B32B 7/02; B32B 27/36; B32B 27/40; B32B 27/08; B32B 27/34; B32B 27/30; B32B 27/32

(52) U.S. Cl. 428/212; 428/480; 428/423.1; 428/412; 428/474.4; 428/473.5; 428/500

(57) ABSTRACT

An antistatic antiglare film that can remain antistatic and transparent even after a long time of use, particularly even after a long time of use at high temperature or high humidity. The antistatic antiglare film of the invention includes a transparent substrate film and an antiglare layer disposed thereon, the antiglare layer includes a polymeric antistatic agent, optically-transparent fine particles and a binder.

### TECHNICAL FIELD

The invention relates to an antistatic antiglare film imparting antistatic properties to an antiglare film, which can function to prevent reflection of external light or to make a displayed image clearly visible, when attached to or placed on the front face of a liquid crystal display, a cathode-ray tube (CRT) display, a plasma display panel, or the like.

### BACKGROUND ART

In such displays, if light emitted from the inside basically goes straight without being diffused at the display surface, the display surface can be visually glaring. Therefore, an antiglare film having fine irregularities on the surface is provided on the display surface so that light emitted from the inside can be diffused to some extent and that external light can be prevented from being reflected on the display surface.

Such an antiglare film is generally formed by applying a resin material containing a filler such as silicon dioxide (silica) to the surface of a transparent substrate film. A certain type of the antiglare film has irregularities formed on the surface of an antiglare layer by agglomeration of particles such as cohesive silica. Another type of the antiglare film is a coating film having irregularities formed on the surface of the coating by adding, to a resin, an organic filler whose particle size is more than the coating thickness. A further type of the antiglare film is formed by laminating an irregular film on the surface of a layer such that the irregularities are transferred.

On the other hand, such displays and so on need to have antistatic properties such that surface static electricity-induced failures can be avoided.

In order to form a film in which two types of properties, antiglare and antistatic properties, are simultaneously improved, a coating liquid containing a mixture of an inorganic filler and an electrically-conductive filler has been applied to a transparent support. In order to form an antiglare film with antistatic properties, a certain process also has been performed that includes forming an antistatic underlayer containing electrically-conductive fine particles and forming an antiglare layer thereon (see for example Patent Document 1 listed below). However, the lamination of the two layers, antistatic and antiglare layers, has the problem of high manufacturing cost.

Thus, a single layer serving as both an antistatic layer and an antiglare layer has been proposed (see for example Patent Documents 2 and 3 listed below). In these literatures, metal oxides are dominantly used as antistatic agents. In order to provide antistatic properties, however, a large amount of a metal oxide must be added to the antiglare layer, which causes the problem of coloration of the film. Therefore, metal oxides are not preferred.

Antistatic agents also include organic antistatic agents. Conventional methods using an organic antistatic agent generally include using a low-molecular-weight surfactant as an organic antistatic agent and applying the surfactant to a surface or forming a coating film as an antistatic layer from a coating composition containing the surfactant. However, low-molecular-weight surfactants have problems in which (1) the antistatic agent can be detached by washing with water, wiping with a cloth or the like so that the antistatic effect is not persistent; (2) most of the low-molecular-weight surfactants have low heat resistance and can be easily decomposed during a forming process so that the antistatic effect is not persistent; (3) the antistatic agent can bleed out to the surface to cause blocking or the like and degrade the surface characteristics; (4) the antistatic agent may concentrate at the interface of a coating film to reduce the adhesion of the coating film so that the upper layer can be easily separated; and (5) the antistatic agent can easily bleed out to the surface to produce a whitish appearance and to reduce the transparency.

Therefore, conventional techniques have a problem in which transparency or antistatic performance can be degraded after a heat or humidity resistance test.

Concerning organic antistatic agents for use in antistatic treatment, ionic polymer compounds are also disclosed (see Patent Document 4 listed below).

Patent Document 1: Japanese Patent Application Laid-Open (JP-A) No. 2002-254573

Patent Document 2: JP-A No. 2002-277602

Patent Document 3: JP-A No. 2003-39607

Patent Document 4: JP-A No. 2000-352620

### DISCLOSURE OF THE INVENTION

### Problems to be Solved by the Invention

The invention has been made under the circumstances described above, and an object of the invention is to provide an antistatic antiglare film that can remain antistatic and transparent even after a long time of use, particularly even after a long time of use at high temperature or high humidity.

### Means for Solving the Problems

The invention is directed to an antistatic antiglare film comprising a transparent substrate film and an antiglare layer that is disposed on the transparent substrate film and comprises a polymeric antistatic agent, optically-transparent fine particles and a binder.

According to the invention, because the polymeric antistatic agent is used in the antiglare layer, the polymeric antistatic agent is intertwined with the binder component to form the coating film. Therefore, while the polymeric antistatic agent gathers at or near the surface of the coating film and exerts the antistatic effect, even when the antiglare layer is washed with water or wiped with a cloth, the polymeric antistatic agent is less likely to be detached and does not form a whitish scum and thus does not degrade the transparency. The heat resistance of the polymeric antistatic agent is also higher than that of low-molecular-weight antistatic agents such as surfactants. In the antiglare layer according to the invention, therefore, the antistatic agent gathering at or near the surface of the coating film effectively performs the antistatic function, and the antistatic properties and the transparency can be maintained even after a long time of use, particularly even after a long time of use at high temperature or high humidity, and the surface characteristics can be less likely to be degraded. The antiglare layer according to the invention can also serve as an antistatic layer in the form of a single layer, and, therefore, there is no need to form a laminate of an antiglare layer and an antistatic layer independent of each other, so that the number of coating processes and thus the cost can be advantageously reduced.

In the antistatic antiglare film of the invention, the antistatic agent is preferably a polymeric quaternary ammonium salt, because adhesion and particularly transparency can be well maintained with it even after a long time of use at high temperature and high humidity.

In the antistatic antiglare film of the invention, the polymeric quaternary ammonium salt is preferably a polymer including 1 to 70% by mole of a quaternary ammonium salt-containing repeating unit in terms of providing antistatic performance and high transparency in a well balanced manner.

In the antistatic antiglare film of the invention, the antiglare layer preferably has a surface resistivity of 10¹³ Ω/square or less in terms of preventing the attachment of dust.

The antistatic antiglare film of the invention preferably has a haze difference of 20% or less according to JIS K 7105 (1981) between before and after it is allowed to stand in a high-temperature, high-humidity chamber at a temperature of 80° C. and a humidity of 90% for 500 hours.

In view of display visibility, the antistatic antiglare film of the invention more preferably further includes a low-refractive-index layer that is placed on the antiglare layer and has a refractive index lower than that of the antiglare layer.

### EFFECTS OF THE INVENTION

The antistatic antiglare film of the invention can remains antistatic and transparent even after a long time of use, particularly even after a long time of use at high temperature or high humidity.

In the antistatic antiglare film of the invention, the antiglare layer also has antistatic properties. Therefore, the antistatic antiglare film of the invention can be produced with higher efficiency at lower cost.

### BRIEF DESCRIPTION OF DRAWINGS

FIG. 1 is a cross-sectional view schematically showing an example of the antistatic antiglare film of the invention.

FIG. 2 is a cross-sectional view schematically showing another example of the antistatic antiglare film of the invention.

### EXPLANATION OF REFERENCE NUMERALS

1: an antistatic antiglare film
2: a transparent substrate film
3: an antiglare layer
4: a low-refractive-index layer

### BEST MODE FOR CARRYING OUT THE INVENTION

The invention is described in detail below. As used herein, the term “(meth)acryloyl” refers to acryloyl and methacryloyl, and the term “(meth)acrylate” refers to acrylate and methacrylate.

The antistatic antiglare film of the invention comprises a transparent substrate film and an antiglare layer disposed thereon, the antiglare layer comprising a polymeric antistatic agent, optically-transparent fine particles and a binder.

In the antistatic antiglare film of the invention, the antiglare layer comprises a polymeric antistatic agent so that the antistatic agent gathering at or near the surface of the antiglare layer effectively performs the antistatic function, and the antistatic properties and the transparency can be maintained even after a long time of use, particularly even after a long time of use at high temperature or high humidity, and the surface characteristics can be less likely to be degraded. In the antistatic antiglare film of the invention, the antiglare layer can also serve as an antistatic layer in the form of a single layer, and, therefore, there is no need to form a laminate of an antiglare layer and an antistatic layer independent of each other, so that the number of coating processes and thus the cost can be advantageously reduced.

In an embodiment of the invention, the antistatic antiglare film including the transparent substrate film and the antiglare layer that is disposed thereon and contains the polymeric antistatic agent may also include one or more additional functional layers, such as a hard coat layer and a low-refractive-index layer.

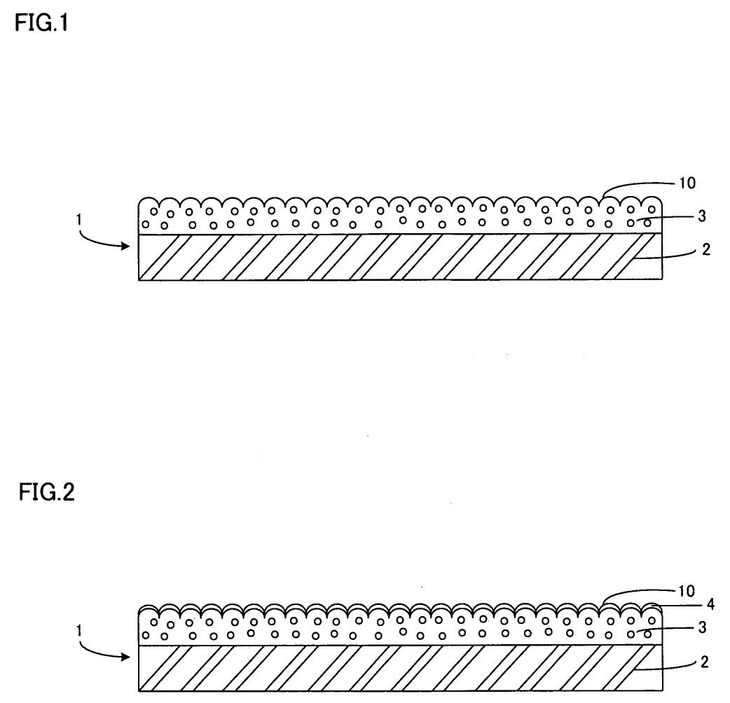

FIGS. 1 and 2 are each a diagram showing an example of the cross-sectional structure of the antistatic antiglare film of the invention. In an embodiment of the invention, as shown in FIG. 1, an antistatic antiglare film 1 comprises a transparent substrate film 2 and an antiglare layer 3 having antistatic properties formed on the substrate film 2. The antiglare layer 3 contains fine particles that are dispersed in the layer 3 in order to diffuse light. The fine particles are dispersed such that the upper surface of the antiglare layer 3 has irregularities 10. In another embodiment of the invention, as shown in FIG. 2, in addition to the structure described above, the antistatic antiglare film 1 may further comprise a low-refractive-index layer 4 that is formed on the antiglare layer 3 and has a refractive index lower than that of the antiglare layer 3. While only the low-refractive-index layer forms an optically-transparent layer in the embodiment shown in FIG. 2, another optically-transparent layer with a different refractive index may be further provided.

Examples of the layered structure of the antistatic antiglare film of the invention include, but are not limited to, transparent substrate film/antiglare layer, transparent substrate film/hard coat layer/antiglare layer, transparent substrate film/antiglare layer/low-refractive-index layer, and transparent substrate film/hard coat layer/antiglare layer/low-refractive-index layer. In the invention, the “antiglare layer” may be a single layer or a multilayer structure.

Elements of the invention are described below in order from the essential elements, the transparent substrate film and the antiglare layer, to other elements.

<Transparent Substrate Film>

The material for the transparent substrate film to be used may be, but not limited to, a general antiglare film material. Materials with smoothness, heat resistance and high mechanical strength are particularly preferred. The transparent substrate film may be made of any of various resins such as triacetate cellulose (TAC), polyester (such as polyethyleneterephthalate (PET) and polyethylene naphthalate), diacetylcellulose, acetate butyrate cellulose, polyethersulfone, acrylic resins (such as poly(methyl acrylate), poly(methyl methacrylate), polyacrylate, and polymethacrylate), polyurethane resins, polycarbonate, polysulfone, polyether, polyamide, polyimide, polypropylene, polymethylpentene, polyvinyl chloride, polyvinyl acetal, polyether ketone, and poly(meth)acrylonitrile. In particular, a triacetylcellulose film or a polyester film (such as a polyethylene terephthalate film and a polyethylene naphthalate film) is preferably used as the transparent substrate film in the antiglare film of the invention. In an embodiment of the invention, when a triacetylcellulose film is used as the transparent substrate film, the antistatic antiglare film of the invention is preferably used as a protective film to protect a polarizing layer of a polarizing plate.

Besides the above, a film of an amorphous olefin polymer having an alicyclic structure (Cyclo-Olefin-polymer (COP)) may also be used. A norbornene polymer, a monocyclic olefin polymer, a cyclic conjugated diene polymer, a vinyl alicyclic hydrocarbon polymer resin, or the like may be used as such a substrate. Examples of such a polymer include Zeonex and Zeonor series (norbornene resins) manufactured by Nippon Zeon Co., Ltd., Sumilite FS-1700 manufactured by Sumitomo Bakelite Company Limited, Arton series (modified norbornene resins) manufactured by JSR Corporation, Apel series (cyclic olefin copolymers) manufactured by Mitsui Chemicals, Inc., Topas series (cyclic olefin copolymers) manufactured by Ticona, and Optrez OZ-1000 series (alicyclic acrylic resins) manufactured by Hitachi Chemical Co., Ltd. FV series (low-birefringence, low-photoelasticity films) manufactured by Asahi Kasei Chemicals Corporation are also preferred.

In an embodiment of the invention, any of these thermoplastic resins is preferably used in the form of a flexible thin film. If hardness is required, however, a plate-shaped material such as a plate of any of these thermoplastic resins and a glass plate may also be used.

The thickness of the substrate is generally from about 25 μm to about 1000 μm. In particular, the thickness of the substrate is preferably from 20 μm to 300 μm and more preferably has an upper limit of 200 μm or less and a lower limit of 30 μm or more. If the optically-transparent substrate is in the form of a plate, its thickness may be more than the above thickness.

When a triacetylcellulose film is used as the transparent substrate film, its thickness is generally from about 25 μm to about 100 μm, preferably from 30 μm to 90 μm, particularly preferably from 35 μm to 80 μm. A thickness of less than 25 μm is not preferred, because of difficult handling during film production.

Before the antiglare layer is formed on the substrate, physical treatment such as corona discharge treatment and oxidation treatment or application of a coating material called an anchor agent or a primer may be performed on the substrate in order to increase the adhesion.

<Antiglare Layer>

In an embodiment of the invention, the antiglare layer has fine irregularities on its surface and provides an antiglare function.

In an embodiment of the invention, the antiglare layer comprises, as essential components, a polymeric antistatic agent, optically-transparent fine particles for imparting antiglare properties, and a binder, for imparting adhesion to the substrate or the adjacent layer and optionally comprises an additive such as a leveling agent or an inorganic filler for controlling the refractive index, preventing crosslink-induced shrinkage or imparting high indentation strength.

In an embodiment of the invention, the antiglare layer may be a single irregular layer or an irregular multilayer structure. When the antiglare layer is a multilayer structure, it preferably comprises an irregular undercoat layer and a surface profile control layer formed on the irregular undercoat layer. The surface profile control layer functions to control the surface shape of the irregular undercoat layer to a more appropriate irregular shape. When the antiglare layer is a multilayer structure, the polymeric antistatic agent is preferably contained in a layer closer to the display viewer. When the antiglare layer includes an irregular undercoat layer and a surface profile control layer formed thereon, therefore, the polymeric antistatic agent is preferably contained in the surface profile control layer, which is located closer to the display viewer. When the antiglare layer is a multilayer structure, the irregular undercoat layer has irregularities on its surface and may be formed by substantially the same method as a single irregular antiglare layer.

First, each component of the antiglare layer is described below.

[Polymeric Antistatic Agent]

According to the invention, a polymeric antistatic agent is used to impart antistatic properties to the antiglare layer. In the antiglare layer, the polymeric antistatic agent can be intertwined with the binder to form a coating film. Therefore, while the polymeric antistatic agent gathers at or near the surface of the coating film and exerts the antistatic effect, even when the antiglare layer is washed with water or wiped with a cloth, the polymeric antistatic agent is less likely to be detached and does not form a whitish scum and thus does not degrade the transparency. The heat resistance of the polymeric antistatic agent is also higher than that of low-molecular-weight antistatic agents such as surfactants. In the antiglare layer according to the invention, therefore, the antistatic agent gathering at or near the surface of the antiglare layer effectively performs the antistatic function, and the antistatic properties and the transparency can be maintained even after a long time of use, particularly even after a long time of use at high temperature or high humidity, and the surface characteristics can be less likely to be degraded.

Examples of polymeric antistatic agents that may be used for the antiglare layer according to the invention include ionene polymers having a dissociable group in the main chain as disclosed in Japanese Patent Application Publication (JP-B) Nos. 49-23828, 49-23827, 47-28937, and 55-734, and JP-A Nos. 50-54672, 59-14735, 57-18175, 57-18176, and 57-56059; and cationic polymer compounds as disclosed in JP-B Nos. 53-13223, 57-15376, 53-45231, 55-145783, 55-65950, 55-67746, 57-11342, 57-19735, 58-56858, and JP-A Nos. 61-27853, 62-9346, 10-279833, and 2000-80169.

In particular, the polymeric antistatic agent is preferably a polymeric quaternary ammonium salt containing a quaternary ammonium cation (a polymeric cationic antistatic agent). Such a polymeric quaternary ammonium salt is preferably used as the antistatic agent, because good adhesion can be maintained even after a high-temperature or high-humidity resistance test and because transparency reduction can be most suppressed after a high-temperature or high-humidity resistance test. Examples of the structure of such a quaternary ammonium salt that may be contained in the polymeric antistatic agent include, but are not limited to, the structures shown below.

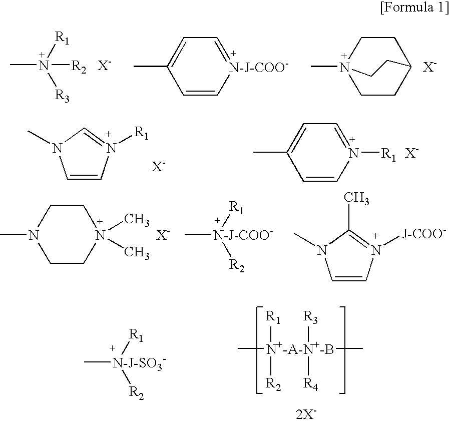

In the formula, R₁, R₂, R₃, and R₄ each represent a substituted or unsubstituted alkyl group having 1 to 4 carbon atoms, and R₁ and R₂ and/or R₃ and R₄ may be linked to form a nitrogen-containing heterocyclic ring such as piperazine. X⁻ represents an anion. A, B and J each represent substituted or unsubstituted C₂ to C₁₀ alkylene, arylene, alkenylene, arylenealkylene, —R₇COR₈—, —R₉COOR₁₀OCOR₁₁—, —R₁₂OCR₁₃COOR₁₄—, —R₁₅—(OR₁₆)ₙ—, —R₁₇CONHR₁₈NHCOR₁₉—, —R₂₀OCONHR₂₁NHCOR₂₂—, or —R₂₅NHCONHR₂₄NHCONHR₂₅—. R₇, R₈, R₉, R₁₁, R₁₂, R₁₄, R₁₅, R₁₆, R₁₇, R₁₉, R₂₀, R₂₂, and R₂₅ each represent an alkylene group, and R₁₀, R₁₃, R₁₈, R₂₁, and R₂₄ each represent a linking group selected from substituted or unsubstituted alkylene, alkenylene, arylene, arylenealkylene, and alkylenearylene groups, and n represents a positive integer of 1 to 4.

The substituted or unsubstituted alkyl group having 1 to 4 carbon atoms may be, but not limited to, a straight or branched chain alkyl group, and examples thereof include methyl, ethyl, n-propyl, isopropyl, n-butyl, isobutyl, tert-butyl, and pentyl groups. Examples of the anion X⁻ include Cl⁻, Br⁻, I⁻, F⁻, HSO₄⁻, SO₄²⁻, NO₃⁻, PO₄³⁻, HPO₄²⁻, H₂PO₄⁻, C₆H₅⁻, SO₃⁻, and OH⁻. In particular, X⁻ is preferably halogen ion, specifically Cl⁻, because it can be easily coupled to the quaternary ammonium.

The polymeric quaternary ammonium salt is a polymer having a quaternary ammonium salt-containing repeating unit. Examples of the quaternary ammonium salt-containing repeating unit or copolymers having the quaternary ammonium salt-containing repeating unit include, but are not limited to, those shown below.

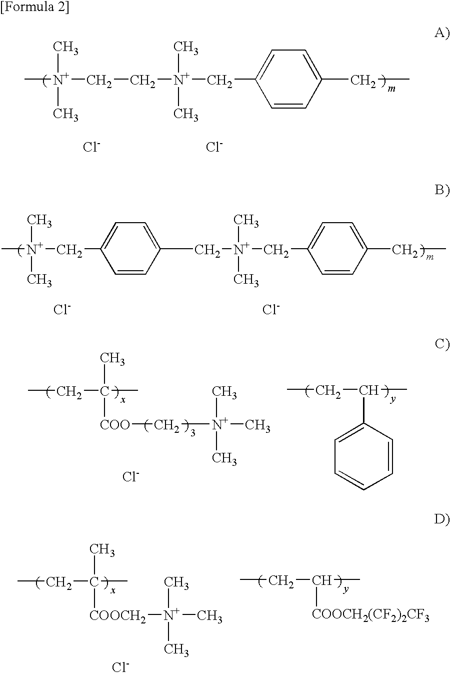

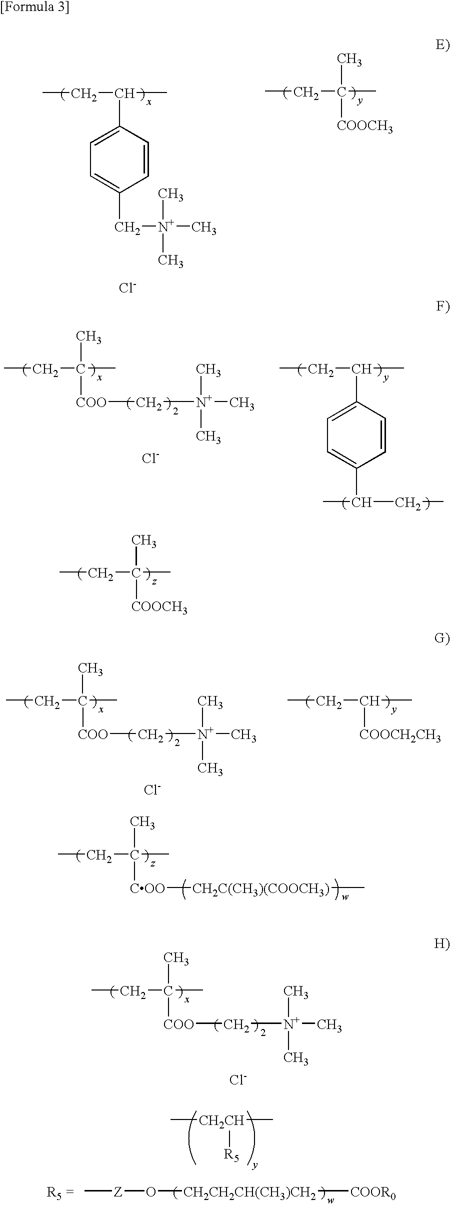

The polymeric quaternary ammonium salt is preferably a polymer including 1 to 70% by mole of a quaternary ammonium salt-containing repeating unit (in the above formulae, the repeating unit with a subscript of m or x) in terms of providing antistatic performance and high transparency in a well balanced manner. If the quaternary ammonium salt-containing repeating unit is less than 1% by mole, the antistatic performance can fail to be delivered. If it is more than 70% by mole, it can have low compatibility with the binder component. The content of the quaternary ammonium salt-containing repeating unit in the polymeric quaternary ammonium salt is more preferably from 3 to 50% by mole.

In addition, the polymeric quaternary ammonium salt preferably contains a hydrophobic group such as a polyoxyethylene group, so that it can have high solubility in solvents or the binder described later.

The polymeric antistatic agent may have a polymerizable functional group. In such a case, it can form a chemical bond with an ionizing radiation-curable binder or the like upon ultraviolet irradiation or electron beam irradiation so that the antistatic agent can be more strongly immobilized in the binder component, which is preferred, because bleeding out of the antistatic agent or detachment of the antistatic agent upon washing with water or wiping with a cloth can be further reduced. Examples of the polymerizable functional group include, but are not limited to, ethylenic unsaturated bond groups such as acryl, vinyl and allyl groups, and an epoxy group.

In an embodiment of the invention, the content of the polymeric antistatic agent in the antiglare layer is preferably from 3 to 20% by mass, based on the total solid mass of the antiglare layer.

[Binder]

The antiglare layer according to the invention contains a binder in view of film formability, film strength or the like. The binder to be used should be optically-transparent such that a coating film made therefrom can transmit light.

In particular, an ionizing radiation-curable resin composition and/or a thermosetting resin composition is preferably used as the binder in order to form a coating film with a high level of mechanical strength or scratch resistance and in order to strongly immobilize the polymeric antistatic agent in such a manner that the polymeric antistatic agent gathering at or near the surface of the coating film can less likely to move or degrade even at high temperature or high humidity. In particular, an ionizing radiation-curable resin composition and/or a thermosetting resin composition that can enhance the coating film performance such as scratch resistance and strength and can form a hard coat layer showing a hardness of “H” or higher in the pencil hardness test according to JIS 5600-5-4 (1999) is preferably used. The ionizing radiation-curable resin composition is more preferably used, because it can be cured in a relatively short time.

The ionizing radiation-curable resin composition may include a monomer, an oligomer and a polymer each having a curable functional group that can promote a large molecule-forming reaction such as dimerization and polymerization directly upon ionizing irradiation or indirectly under the action of an initiator. Specifically, a radical-polymerizable monomer or oligomer having an ethylenic unsaturated bond group such as (meth)acryloyl, vinyl and allyl is preferred, and a polyfunctional binder component that has two or more (preferably three or more) curable functional groups in a single molecule such that crosslinking can be formed between the binder component molecules is preferred. When the binder component has an ethylenic unsaturated bond, a photo-radical polymerization reaction can occur directly upon the application of ionizing radiation such as ultraviolet light and electron beam or indirectly under the action of an initiator, so that the operation including a photocuring process can be relatively easy. Among these groups, the (meth)acryloyl group is preferred, because it can provide high productivity. However, any other ionizing radiation-curable binder component may also be used such as a photocationically polymerizable monomer or oligomer such as an epoxy group-containing compound.

The ionizing radiation-curable composition preferably comprises an ionizing radiation-curable resin that contains an ethylenic unsaturated bond group (such as an acrylate functional group)-containing, relatively-low-molecular-weight, polyester resin, polyether resin, acrylic resin, epoxy resin, urethane resin, alkyd resin, spiroacetal resin, polybutadiene resin, or polythiol-polyene resin, or an oligomer or prepolymer of (meth)acrylate of a polyfunctional compound such as a polyhydric alcohol, and a relatively large amount of a reactive diluent. Examples of the reactive diluent include monofunctional monomers such as ethyl (meth)acrylate, 2-ethylhexyl (meth)acrylate, styrene, vinyltoluene, and N-vinylpyrrolidone; and polyfunctional monomers such as trimethylolpropane tri(meth)acrylate, 1,6-hexanediol di(meth)acrylate, tripropylene glycol di(meth)acrylate, diethylene glycol di(meth)acrylate, pentaerythritol tri(meth)acrylate, dipentaerythritol hexa(meth)acrylate, and neopentylglycol di(meth)acrylate. In an embodiment of the invention, a mixture of a urethane acrylate oligomer and a dipentaerythritol hexa(meth)acrylate monomer is particularly preferred.

When the ionizing radiation-curable resin to be used is an ultraviolet-curable resin, a photopolymerization initiator such as an acetophenone compound, a benzophenone compound, Michler's benzoyl benzoate, α-amyloxime ester, or a thioxanthone compound and a photosensitizer such as n-butylamine, triethylamine, or tri-n-butylphosphine may be used and mixed into the binder. When the resin has a cationically-polymerizable functional group, an aromatic diazonium salt, an aromatic sulfonium salt, an aromatic iodonium salt, a metallocene compound, a benzoin sulfonate ester, and so on may be used alone or in combination as a photopolymerization initiator. Various photopolymerization initiators described in Saishin UV Koka Gijutsu (Latest UV Curing Techniques) p. 159, published by Kazuhiro Takausu, Technical Information Institute Co., Ltd., 1991 may also be used in an embodiment of the invention.

Preferred examples of commercially-available, photo-cleavage type, photo-radical polymerization initiators include Irgacure 651 (trade name), Irgacure 184 (trade name, 1-hydroxy-cyclohexyl-phenyl-ketone), and Irgacure 907 (trade name) each manufactured by Ciba Specialty Chemicals Inc.

The photopolymerization initiator is preferably used in an amount of 0.1 to 15 parts by mass, more preferably of 1 to 10 parts by mass, based on 100 parts by mass of the ionizing radiation-curable resin.

The ionizing radiation-curable composition may also contain a solvent drying type resin. A thermoplastic resin is generally used as the solvent drying type resin. Examples of such a thermoplastic resin include styrene resins, (meth)acrylic resins, vinyl acetate resins, vinyl ether resins, halogen-containing resins, alicyclic olefin resins, polycarbonate resins, polyester resins, polyamide resins, cellulose derivatives, silicone resins, rubbers, and elastomers. The thermoplastic resin is preferably amorphous and soluble in an organic solvent (particularly in a common solvent capable of solubilizing different polymers or curable compounds). In view of film formability, transparency and weather resistance, styrene resins, (meth)acrylic resins, alicyclic olefin reins, polyester resins, cellulose derivatives (such as cellulose esters), and the like are particularly preferred. Cellulose resins such as nitrocellulose, acetylcellulose, cellulose acetate propionate, and ethyl hydroxyethyl cellulose are advantageous as the thermoplastic resin, in view of adhesion and transparency in the case where a triacetylcellulose film is used as the transparent substrate film.

The thermosetting resin composition may include a monomer, an oligomer and a polymer each having a curable functional group that can promote a large molecule-forming reaction for curing, such as polymerization or crosslinking, between the same or different functional groups, upon heating. A monomer, oligomer or the like having an alkoxy group, a hydroxyl group, a carboxyl group, an amino group, an epoxy group, a hydrogen bond-forming group, or the like may be used for the thermosetting resin. Examples of the thermosetting resin that may be used include phenol resins, urea resins, diallyl phthalate resins, melamine resins, guanamine resins, unsaturated polyester resins, polyurethane resins, epoxy resins, aminoalkyd resins, melamine-urea cocondensated resins, silicon reins, and polysiloxane resins. If necessary, a curing agent such as a crosslinking agent and a polymerization initiator, a polymerization promoter, a solvent, a viscosity modifier, or the like may be added to the thermosetting resin composition before use.

In an embodiment of the invention, the content of the binder in the antiglare layer is preferably from 15 to 85% by mass, based on the total solid mass of the antiglare layer.

[Optically-Transparent Fine Particles]

In an embodiment of the invention, the antiglare layer contains optically-transparent fine particles to form surface irregularities and to impart antiglare properties.

A single type of optically-transparent fine particles or two or more types of optically-transparent fine particles different in component, shape, particle size distribution, or the like may be used alone or in combination, depending on the purpose. One to three types are preferably used. In addition, many types of particles may also be used for purposes other than the formation of irregularities.

One or more types of optically-transparent fine particles for use in the invention may be in the form of balls such as spheres and ellipsoidal shapes, more preferably in the form of spheres. The average particle size (μm) of each of one or more types of optically-transparent fine particles is preferably from 0.5 μm to 20 μm, more preferably from 0.5 μm to 10.0 μm. If it is less than 0.5 μm, a very large amount of optically-transparent fine particles should be added to the antiglare layer, otherwise it can be difficult to achieve sufficient antiglare properties or a sufficient light diffusing effect. If it is more than 20 μm, the surface profile of the antiglare layer can be rough so that the surface quality can be degraded or the surface haze can increase to enhance a whitish tint. The average particle size of the optically-transparent fine particles may refer to the average particle size of monodisperse particles (particles with the same shape) or the average particle size of the most frequent particles which are determined by size distribution measurement of indefinite-shape or amorphous particles with a broad particle size distribution. The particle size of the fine particles may be generally measured by Coulter counter method. It may also be measured by any other method such as laser diffraction method and SEM photography. The optically-transparent fine particles may be aggregate particles. In that case, the secondary particle size is preferably in the above range.

Eighty percents or more (preferably 90% or more) of the optically-transparent fine particles each preferably have a particle size in the range of the average particle size ±1.0 μm (preferably 0.3 μm). This allows the formation of highly uniform irregularities in the antiglare layer. If fine particles with an average particle size of less than 3.5 μm are used, however, fine particles with particle sizes out of the above range, such as indefinite-shape fine particles with a size of 2.5 μm or 1.5 μm may be used.

The optically-transparent fine particles may be, but not limited to, inorganic or organic fine particles. Specifically, fine particles made of an organic material include plastic beads. Examples of plastic beads include styrene beads (1.60 in refractive index), melamine beads (1.57 in refractive index), acrylic beads (1.50 to 1.53 in refractive index), acrylic-styrene beads (1.54 to 1.58 in refractive index), benzoguanamine beads, benzoguanamine-formaldehyde condensate beads, polycarbonate beads, and polyethylene beads. The plastic beads preferably have a hydrophobic group on their surface, and examples of such beads include styrene beads. Examples of inorganic fine particles include amorphous silica and inorganic silica beads.

The amorphous silica is preferably used in the form of silica beads with particle sizes of 0.5 to 5 μm and good dispersibility. In order that the amorphous silica may be well dispersed in the antiglare layer-forming coating liquid (described in detail later) without an increase in the viscosity thereof, the particle surface of the amorphous silica to be used is preferably made hydrophobic by organic material treatment. Examples of the organic material treatment include a method of chemically bonding a certain compound to the surface of the beads and a physical method of impregnating voids or the like of the bead-forming composition with a certain compound without chemically bonding it to the surface of the beads. Any of these methods may be used. In general, chemical treatment with the aid of an active group on the silica surface, such as a hydroxyl or silanol group, is preferably used in view of treatment efficiency. Compounds highly reactive with the active group, such as silanes, siloxanes and silazanes, may be used for the treatment. Examples of such compounds include straight chain alkyl-monosubstituted silicones, branched alkyl-monosubstituted silicones, straight chain alkyl-polysubstituted silicone compounds such as di-n-butyldichlorosilane and ethyldimethylchlorosilane, and branched chain alkyl-polysubstituted silicone compounds. Straight or branched chain alkyl-monosubstituted or polysubstituted siloxanes or silazanes may also be effectively used.

The compounds to be used may also have a heteroatom, an unsaturated bond group, a cyclic bond group, an aromatic functional group, or the like at the end of the alkyl chain or at an intermediate site of the alkyl chain, depending on the necessary function.

In these compounds, the alkyl group exhibits hydrophobicity. By the treatment with these compounds, therefore, the surface of the material can be easily converted from hydrophilic to hydrophobic so that it can have a high affinity for polymer materials which would otherwise be poor in affinity without the treatment.

In an embodiment of the invention, when two or more types of optically-transparent fine particles are used and mixed, the formulae (I): 0.25R₁ (preferably 0.50R₁)≦R₂≦1.0R₁ (preferably 0.70R₁), wherein R₁ (μm) is the average particle size of a first type of fine particles, and R₂ (μm) is the average particle size of a second type of fine particles, should preferably satisfied. If R₂ is 0.25R₁ or more, the particles can be easily dispersed in a coating liquid without aggregation. In addition, the particles can be free from the influence of air blowing during floating in a drying process after coating so that they can form uniform irregularities. This relation may also apply to the relation of the second type of fine particles to a third type of fine particles. The formula: 0.25R₂≦R₃≦1.0R₂, wherein R₃ (μm) is the average particle size of the third type of fine particles, is preferably satisfied.

When a mixture of two or more types of fine particles comprising different components is used, the two or more types of fine particles may be preferably the same in average particle size, although the average particle size of the two or more types of fine particles may be preferably different as above described.

In another embodiment of the invention, concerning the total mass ratio between the binder, a first type of fine particles and a second type of fine particles, per unit area, the formula (II): 0.08≦(M₁+M₂)/M≦0.36 and the formula (III): 0≦M₂≦4.0M₁ are preferably satisfied, wherein M₁ is the total mass of the first type of fine particles per unit area, M₂ is the total mass of the second type of fine particles per unit area, and M is the total mass of the binder per unit area.

In particular, the content of the second type of fine particles is preferably from 3 to 100% by mass of the first type of fine particles. When three or more types of fine particles are contained, the content of a third type of fine particles is preferably from 3 to 100% by mass of the second type of fine particles. This relation may preferably apply to the content of a fourth or higher order type of fine particles.

In a preferred embodiment of the invention, the antiglare layer has not only antiglare properties provided by the formation of surface irregularities but also internal scattering properties provided by a difference between the refractive indices of the matrix and the optically-transparent fine particles (the larger the refractive index difference, the higher the internal scattering properties). The internal scattering properties can provide a solution to a glare problem with antiglare films (a phenomenon in which surface irregularities act as a lens to cause variations in brightness and a reduction in visibility particularly in high definition displays with a small pixel size).

In order to reduce such glare, the optically-transparent fine particles are preferably used such that there is a refractive index difference of 0.03 to 0.20 between the binder and the optically-transparent fine particles. The difference between the refractive indices of the binder and the optically-transparent fine particles in the antiglare layer is preferably from 0.03 to 0.20, because if the refractive index difference is less than 0.03, the refractive index difference between them can be too small to produce the light diffusing effect and because if the refractive index difference is more than 0.20, the light diffusion can be so high that the film can become entirely whitish. In particular, the refractive index difference between the optically-transparent fine particles and the binder is preferably from 0.04 to 0.16.

Two or more types of optically-transparent fine particles with different refractive indices may be used and mixed. In this case, an average calculated from the refractive indices of the respective types of optically-transparent fine particles and the content ratio between them may be considered as the refractive index of the optically-transparent fine particles. In this case, fine adjustment of the refractive index can be performed by controlling the mixing ratio of the optically-transparent fine particles. The control is easier in this case than in the case of a single type, so that various designs will be possible.

In an embodiment of the invention, therefore, the optically-transparent fine particles used may include two or more types of optically-transparent fine particles with different refractive indices. In this case, the difference between the refractive indices of first and second types of optically-transparent fine particles is preferably from 0.03 to 0.10. Among the optically-transparent fine particles, the first and second types of optically-transparent fine particles preferably have a refractive index difference of 0.03 to 0.10, because if the refractive index difference is less than 0.03, the refractive index difference between them can be so small that the flexibility of the refractive index control can be low even in the mixture thereof and because if the refractive index difference is more than 0.10, the light diffusion properties can be determined only by the optically-transparent fine particles with a refractive index more different from that of the matrix. The refractive index difference is preferably from 0.04 to 0.09, particularly preferably from 0.05 to 0.08.

It is preferred that a first type of optically-transparent fine particles to be added to the antiglare layer should have particularly high transparency and have a refractive index such that the refractive index difference between the binder and the first type of optically-transparent fine particles may be as described above. Examples of organic fine particles for use as the first type of optically-transparent fine particles include acrylic beads (1.49 to 1.533 in refractive index), acrylic-styrene copolymer beads (1.55 in refractive index), melamine beads (1.57 in refractive index), and polycarbonate beads (1.57 in refractive index). Inorganic fine particles may be amorphous silica beads (1.45 to 1.50 in refractive index).

A second type of optically-transparent fine particles are preferably organic fine particles that have particularly high transparency and have a refractive index such that the refractive index difference between the optically-transparent resin and the second type of optically-transparent fine particles in the combination may be as described above.

Examples of organic fine particles for use as the second type of optically-transparent fine particles include styrene beads (1.60 in refractive index), polyvinyl chloride beads (1.60 in refractive index), and benzoguanamine-formaldehyde condensate beads (1.66 in refractive index).

When two types of optically-transparent fine particles with different refractive indices are used, the particle size of the first type of optically-transparent fine particles may be preferably larger than that of the second type optically-transparent fine particles. However, when the two types of fine particles may have the same particle size, the ratio between the first and second types of optically-transparent fine particles to be used may be freely selected, so that the light diffusion properties can be easily designed. In order to make the particle size of the first type of optically-transparent fine particles substantially equal to that of the second type of optically-transparent fine particles, organic fine particles are preferably used, because monodisperse particles thereof are easy to obtain. Less variation in particle diameter can preferably lead to less variation in antiglare properties or inner scattering properties so that the optical performance of the antiglare layer can be easily designed. Methods for further increasing the monodispersity include wind force classification and wet classification by filtration with filters.

The total content of the optically-transparent fine particles in the antiglare monolayer or the irregular undercoat layer is preferably from 5% by mass to 40% by mass, more preferably from 10% by mass to 30% by mass, based on the total solid mass of the antiglare monolayer or the irregular undercoat layer. If the content is less than 5% by mass, antiglare properties or inner scattering properties can be insufficiently provided. If the content is more than 40% by mass, the film strength can be undesirably reduced so that it can be impossible to impart hard coating properties to the antiglare layer.

[Other Components]

When the optically-transparent fine particles are added in a relatively large amount, they can tend to precipitate in the resin composition, and therefore an inorganic filler such as silica may be added thereto in order to prevent the precipitation. A lager amount of the addition of the inorganic filler can be more effective in preventing the precipitation of the optically-transparent fine particles, but the inorganic filler may have an adverse effect on the transparency of the coating film, depending on the particle size or the amount. Therefore, it is preferred that an inorganic filler with a particle size of 0.5 μm or less should be added to the binder in such an amount that the filler does not cause a reduction in the transparency of the coating film.

The antiglare layer may also contain an inorganic filler for controlling the refractive index. If the refractive index difference between the binder and the optically-transparent fine particles cannot be made appropriately large, an inorganic filler may be added as appropriate to the binder in order to control the refractive index of the matrix of the antiglare layer, which is an optically-transparent fine particle-free portion of an optically-transparent fine particle dispersion. The inorganic filler for use in this case is preferably such that it has a particle size sufficiently smaller than the light wavelength so as not to cause scattering and such that a dispersion of the inorganic filler in the binder can behave as optically-uniform matter.

In an embodiment of the invention, the refractive index of a mixture of the binder, the optically-transparent fine particles and the inorganic filler, namely the refractive index of the antiglare layer, is preferably from 1.48 to 2.00, more preferably from 1.51 to 1.80, still more preferably from 1.54 to 1.70. The matrix of the antiglare layer, which is the optically-transparent fine particle-free portion, preferably has a refractive index of 1.50 to 2.00. In order to set the refractive index in the above range, the type and content of the binder, the optically-transparent fine particles and/or the inorganic filler may be appropriately selected. How to select can be easily determined experimentally in advance.

According to the features described above, if the refractive index difference between the optically-transparent fine particles and the matrix of the antiglare layer is appropriately selected, optimal antiglare properties can be provided, while high transparency and clearness can be maintained without the film becoming entirely whitish, and the light passing through the film can be averaged by the internal scattering effect so that glare can be suppressed.

In order to impart antifouling properties, water resistance, chemical resistance, lubricity, or other properties, a known silicone or fluoride antifouling agent or lubricant or the like may be added as appropriate to the antiglare layer according to the invention. The amount of the addition of any of these additives is preferably from 0.01 to 20% by mass, more preferably from 0.05 to 10% by mass, particularly preferably from 0.1 to 5% by mass, based on the total solids of the antiglare layer.

The antiglare layer may further contain an ultraviolet blocking agent, an ultraviolet absorbing agent, a surface control agent (leveling agent), or any other component.

Next, a description is given of the surface profile control layer which is optionally contained in the antiglare layer.

[Surface Profile Control Layer]

In an embodiment of the invention, the antiglare layer may further include the surface profile control layer, which has the function of controlling the surface shape of the irregular undercoat layer to a more appropriate irregular shape. The surface profile control layer fills in fine irregularities, which are present along the irregular shape, on a scale of 1/10 or less of the surface roughness scale (the peak height and peak-to-peak distance of the irregularities) of the irregular undercoat layer, so that it can smooth the irregular surface or control the peak-to-peak distance, peak height or peak frequency (the number of the peaks) of the irregularities. The surface profile control layer, which is placed on a side closer to the viewer, may further have an additional function such as refractive index control, high hardness or antifouling, in addition to the antistatic function essentially provided according to the invention.

The surface profile control layer can form a more appropriate irregular shape so that, for example, black can be reproduced as desired.

When external light entering the antiglare film is reflected over a wide range of angles, the light can be reflected in any direction (diffused and reflected) toward the viewer's eye, depending on the angle of the irregularities on the surface of the antiglare film, so that desired black cannot be reproduced and can be seen as grayish color (namely, only part of the diffused light reaches the viewer's eye). In contrast, when the surface profile control layer is used to form a more appropriate irregular shape, incident light can be reflected intensively at angles near the specular reflection angle. In this case, therefore, light from a light source hardly undergoes diffuse reflection and is specularly reflected, and only the specularly reflected light reaches the viewer's eye, so that desired glossy black (hereinafter, the desired black is also referred to as glossy black feeling in the description) is reproduced. The glossy black feeling of image displays reflects the reproducibility of black when black is displayed on the image displays in a bright room environment, and it may be evaluated by visual observation.

In a more appropriate irregular shape, in which incident light is reflected intensively at angles near the specular reflection angle, for example, the average distance between the surface irregularities is relatively large so that relatively gentle irregularities are formed. More specifically, for example, Sm is preferably from 50 μm to 200 μm, θa is preferably from 0.3 degrees to 1.0 degree, and Rz is preferably from 0.3 μm to 1.0 μm, wherein Sm is the average distance between irregularities of the uppermost surface of the antiglare layer, θa is the average slope angle of the irregularities, and Rz is the ten point average roughness of the irregularities (Sm, θa and Rz are defied according to JIS B 0601 (1994)).

In this case, measurement conditions for the surface roughness meter used for determining Sm, θa and Rz are as follows: surface roughness meter, Model No. SE-3400 manufactured by Kosaka Laboratory Ltd.; (1) probe needle of surface roughness detection part, Model No. SE2555N (2 μm standard) manufactured by Kosaka Laboratory Ltd., 2 μm in tip curvature radius, 90 degrees in apex angle, made of diamond; and (2) surface roughness meter measurement conditions of a reference length of 0.8 mm (the cut-off value λc of the roughness curve), an evaluation length of 4.0 mm (5 times the reference length (the cut-off value λc) and a probe needle feed speed of 0.1 mm/second.

In an embodiment of the invention, the surface profile control layer formed for the purpose described above may comprise (1) a binder resin or (2) a composition containing organic fine particles and/or inorganic fine particles and a binder resin. The surface profile control layer may be formed by a process that includes applying, to the irregular undercoat layer, a surface profile control layer-forming coating liquid comprising the component (1) or (2) and optionally performing a curing reaction.

The inorganic fine particles that may be added to the surface profile control layer may be in any form such as balls, plates, fibers, indefinite shapes, and hollow shapes. The inorganic fine particles may be of any type such as silica, alkali metal oxide, alkaline earth metal oxide, titanium oxide, zinc oxide, aluminum oxide, boron oxide, phosphate compound, and zirconium oxide.

For example, the organic fine particles that may be added to the surface profile control layer have a moderate crosslinking structure in the interior of the particles and are made from an active energy ray-curing resin or monomer or made of a hard material that less swells with a solvent or the like. For example, the organic fine particles that may be used are mainly composed of intra-particle crosslinked type styrene resin, styrene-acrylic copolymer resin, acrylic resin, divinylbenzene resin, silicone resin, urethane resin, melamine resin, styrene-isoprene resin, benzoguanamine resin, or the like.

The organic or inorganic fine particles may also have a core-shell structure. In this case, a polymerizable functional group may be introduced into the surface of the shell part. In the shell part structure, the polymerizable functional group may be directly bonded to the core, or a monomer, oligomer or polymer having the polymerizable functional group may be bonded in a graft form to the core by a chemical reaction, or a monomer, oligomer or polymer having the polymerizable functional group may be bonded in the form of a coating to the surface of the particle part (core) by a chemical reaction.

The particle part (core) of the core-shell structure-containing fine particle may be an organic or inorganic component, and the shell part may also be an organic or inorganic component. Examples of the core-shell structure-containing fine particles include fine particles entirely made of an organic component (such as polymer latex), fine particles entirely made of an inorganic component, and fine particles entirely made of an organic-inorganic composite component. Examples thereof also include graft fine particles and core-shell fine particles in which one of the particle part (core) and the polymerizable functional group-containing part (graft part or shell part) deposited on the surface thereof is made of an organic material, and the other is made of an inorganic material.

When the core-shell fine particles having a polymerizable functional group on their surface are used, a coating liquid is preferably prepared using a polymerizable functional group-containing resin binder, and the coating liquid is preferably applied to the surface of the irregular undercoat layer and cured. In this process, the polymerizable functional group on the surface of the fine particles and the polymerizable functional group of the binder component react with the binder component when the coating is cured, so that a covalent bond is formed between the binder component and the core-shell fine particles. Therefore, this process is preferred, because it is significantly effective in increasing the strength and adhesion of the coating film and in following the surface irregularities of the irregular undercoat layer. A polyfunctional binder component having two or more polymerizable functional groups in a single molecule is preferably used as the resin binder, because it can form a crosslink. In particular, a relatively small amount of a polyfunctional monomer or oligomer is very preferably added as an aid to the polymerizable functional group-containing fine particles, so that the binding force at the contact point between the fine particles can be significantly increased and that the capability to follow the surface irregularities of the irregular undercoat layer can be further enhanced.

In general, the fine particles for use in forming the surface profile control layer each preferably have a particle part with a primary particle size of 1 nm to 500 nm. If the primary particle size is less than 1 nm, it can be difficult to impart sufficient hardness or strength to the coating film. If the primary particle size is more than 500 nm, the coating film can be reduced in transparency and cannot be used in some applications. The particle sizes of the fine particles may be uniform or have a certain distribution. Two or more types of fine particles with different particle sizes may be used in the form of a mixture, as long as they do not reduce the strength of the coating film. The primary particle size of the fine particles may be measured with an apparatus such as a particle size distribution meter by dynamic light scattering, static light scattering or the like. Alternatively, the primary particle size may be visually determined using a secondary electron emission image photograph obtained with a scanning electron microscope (SEM) or the like. The average particle size of the electrically-conductive metal oxide fine particles may be measured by dynamic light scattering or the like.

Among the fine particles described above, colloidal silica is particularly preferred in an embodiment of the invention. As used herein, the term “colloidal silica” means a colloidal solution containing colloidal silica particles dispersed in water or an organic solvent. For example, the colloidal silica preferably comprises ultrafine particles with a particle size (diameter) of 1 to 70 nm. In an embodiment of the invention, the particle size of the colloidal silica is an average particle size that is calculated by a process including the steps of measuring the specific surface area by BET (Brunauer-Emmett-Teller) method and calculating the average particle size from the specific surface area, assuming that each particle is a sphere.

The colloidal silica is a known material, and examples of commercially available colloidal silica include Methanol Silica Sol, MA-ST-M, IPA-ST, EG-ST, EG-ST-ZL, NPC-ST, DMAC-ST, MEK, XBA-ST, and MIBK-ST (tradenames, all manufactured by Nissan Chemical Industries, Ltd.), and OSCAL 1132, OSCAL 1232, OSCAL 1332, OSCAL 1432, OSCAL 1532, OSCAL 1632, and OSCAL 1132 (trade names, all manufactured by Catalyst & Chemicals Ind. Co., Ltd.).

Concerning the organic or inorganic fine particles, the surface profile control layer preferably contains 5 to 300 parts by mass of the fine particles, base on 100 parts by mass of the binder resin in the surface profile control layer (the ratio of the mass of the fine particles to the mass of the binder resin (P/V ratio) is preferably from 5/100 to 300/100). If the ratio is less than 5/100, the capability to follow the irregularities can be insufficient so that it can be difficult to simultaneously achieve reproduction of black such as glossy black feeling and antiglare properties in some cases. If the ratio is more than 300/100, physical properties such as adhesion and scratch resistance can be insufficient. Therefore, the above range is preferred. In the case of colloidal silica, the content ratio is preferably from 5/100 to 80/100, while it may vary with the type of the fine particles added. The content ratio is preferably 80/100 or less, because the addition with a ratio of more than 80/100 cannot alter the antiglare properties and thus can be useless and because the addition with a ratio of more than 80/100 can cause insufficient adhesion to the lower layer.

Any binder resin that can form an optically-transparent coating film may be used for the surface profile control layer. For example, the ionizing radiation-curable resin composition and/or the thermosetting resin composition described above may be used. The ionizing radiation-curable resin composition is more preferred. The binder resin for use in the surface profile control layer may be the same resin as described in the section “Binder.” If a solvent drying type resin is used in combination for the surface profile control layer, coating surface defects can be effectively prevented so that a higher level of glossy black feeling can be obtained.

A binder resin that is preferably used to form the surface profile control layer may include a compound having three or more curable functional groups. A high-refractive-index compound containing a bromine atom, a sulfur atom and a fluorene skeleton and having at least one curable functional group may also be used alone or in combination with the compound having three or more curable functional groups.

The surface profile control layer may also contain any other appropriate component such as those described for the antiglare layer.

[Method for Forming the Antiglare Layer]

The antiglare layer comprising the respective components (including the surface profile control layer) may be generally formed by a process that includes dissolving and dispersing the respective components in a solvent by a general method to prepare an antiglare layer-forming coating liquid, applying the coating liquid to the transparent substrate film or one or more functional layers on the transparent substrate film, drying the coating, and optionally curing the coating. A shaping process may be performed to form irregularities. However, the method for forming the antiglare layer is not limited to these processes.

(Solvents)

In order to dissolve or disperse solid components, a solvent is preferably used for the antiglare layer-forming coating liquid. The solvent may be of any type, and examples of the solvent include alcohols such as methanol, ethanol and isopropyl alcohol; ketones such as methyl ethyl ketone, methyl isobutyl ketone and cyclohexanone; esters such as methyl acetate, ethyl acetate and butyl acetate; halogenated hydrocarbons; and aromatic hydrocarbons such as toluene and xylene. Ketones and esters are preferred.

The amount of the solvent may be appropriately controlled such that each component can be uniformly dissolved or dispersed, the optically-transparent fine particles do not aggregate even when allowed to stand after the preparation, and the concentration of the coating liquid is not too low. As long as these requirements are satisfied, the amount of the addition of the solvent is preferably as small as possible such that a high concentration coating liquid can be prepared. As a result, the coating liquid can be stored in a small volume and diluted to an appropriate concentration when used for a coating process. Based on 100 parts by weight of the sum of the solids and the solvent, 50 to 99.5 parts by weight of the solvent is preferably used with 0.5 to 50 parts by weight of the total solids, and 70 to 97 parts by weight of the solvent is more preferably used with 3 to 30 parts by weight of the total solids, so that an antiglare layer-forming coating liquid with high dispersion stability suitable for long-term storage can be obtained.

(Preparation of Coating Liquid)

The antiglare layer-forming coating liquid may be prepared by adding and mixing the respective essential components and an optional component(s) in any order. The resulting mixture may be subjected to an appropriate dispersion process with a paint shaker, a bead mill or the like, when the antiglare layer-forming coating liquid is prepared.

(Formation of the Antiglare Layer)

The antiglare layer-forming coating liquid may be applied to the transparent substrate film or one or more other functional layers and dried and then optionally cured by ionizing irradiation and/or heating.

Any of various coating methods such as spin coating, dipping, spraying, slide coating, bar coating, Myer bar coating, roll coating, gravure coating, meniscus coating, flexographic printing, screen printing, and bead coating may be used.

The ionizing radiation-curable resin composition may be cured by a general curing method, specifically by electron beam irradiation or ultraviolet irradiation.

In the case of electron beam irradiation, electron beams with an energy of 50 to 1000 keV, preferably of 100 to 300 keV, emitted from any of various electron beam accelerators such as Cockcroft-Walton type, Van de Graaff type, resonant transformer type, insulated core transformer type, linear type, Dynamitron type, and high frequency type accelerators may be used. In the case of ultraviolet curing, ultraviolet rays in the wavelength range of 190 to 380 nm are preferably used. For example, ultraviolet curing may be performed using ultraviolet rays emitted from an extra-high pressure mercury lamp, a high pressure mercury lamp, a low pressure mercury lamp, a carbon arc lamp, a xenon arc lamp, a metal halide lamp, a black-light fluorescent lamp, or other light sources.

When the antiglare layer is formed by a crosslinking or polymerization reaction of the ionizing radiation-curable resin composition, the crosslinking or polymerization reaction is preferably performed in an atmosphere with an oxygen concentration of 10% by volume or less. An antiglare layer with hard coating properties (scratch resistance) and a high level of mechanical strength and chemical resistance can be formed in the atmosphere with an oxygen concentration of 10% by volume or less. The antiglare layer is preferably formed by a crosslinking or polymerization reaction of the ionizing radiation-curable resin composition in an atmosphere with an oxygen concentration of 3% by volume or less, more preferably with an oxygen concentration of 1% by volume or less, particularly preferably with an oxygen concentration of 0.2% by volume or less, most preferably with an oxygen concentration of 0.1% by volume or less. The method for reducing the oxygen concentration to 10% by volume or less is preferably replacement of the air (with a nitrogen concentration of about 79% by volume and an oxygen concentration of about 21% by volume) with any other gas, particularly preferably with nitrogen (nitrogen purge).

When the resin is cured as describe above, the fine particles in the binder are fixed so that desired irregularities are formed on the uppermost surface of the antiglare layer.

Alternatively, after a coating layer is formed by applying the antiglare layer-forming coating liquid to the transparent substrate film or one or more other functional layers, the surface of the coating layer may be subjected to a shaping process so as to have irregularities, before drying and/or curing. This method is preferably performed by a shaping process using a die or mold having irregularities reverse to the irregularities of the antiglare layer. Examples of the mold with the reverse irregularities (hereinafter also simply referred to as “irregular mold”) include an embossing plate, an embossing roll and so on.

Alternatively, the irregularities may be formed by a process that includes supplying the antiglare layer-forming coating liquid to the interface between an irregular mold and the transparent substrate film or one or more other functional layers so as to interpose it between the irregular mold and the transparent substrate and subjecting it to drying, curing or the like so that irregularities can be formed with the fine particles contained. In this embodiment, a flat embossing plate may be used in place of the embossing roller.

The irregular mold surface of the embossing roller, the flat embossing plate or the like may be formed by any of various known methods such as sand blasting and bead shot blasting. When an embossing plate (embossing roller) formed by sand blasting is used to form the antiglare layer, its cross-section has a large number of concave portions distributed on the upper side. When an embossing plate (embossing roller) formed by bead shot blasting is used to form the antiglare layer, a large number of convex portions are distributed on the upper side.

The antiglare layer having a large number of convex portions distributed on the upper side is considered to be less reflective to room lights and the like than the antiglare layer having a large number of concave portions distributed on the upper side, even though they have the same average roughness with respect to the irregularities formed on their surface. In a preferred embodiment of the invention, therefore, the irregularities of the antiglare layer is preferably formed using an irregular mold having irregularities formed in the same pattern as the irregularities of the antiglare layer by bead shot blasting.

Plastic, metal, wood, or the like or a composite thereof may be used as a material for forming the irregular mold surface. The material for forming the irregular mold surface is preferably chromium metal in view of strength and wear resistance for repeated use or preferably an iron embossing plate (embossing roller) whose surface is plated with chromium, in view of economy or the like.

When irregularities are formed by sand blasting or bead shot blasting, for example, particles (beads) of an inorganic material such as metal, silica, alumina, or glass may be blown. These particles may have particle sizes (diameters) of about 100 μm to about 300 μm. The method of blowing the particles against the mold material may include blowing the particles together with high speed gas. In this process, any appropriate liquid such as water may be used in combination. In an embodiment of the invention, the irregular mold having irregularities is preferably subjected to chromium plating or the like before use, for the purpose of increasing the durability during use. Chromium plating or the like is preferred in terms of hardening- and corrosion protection.

While the antiglare layer may be formed as described above, a multilayered antistatic coating may also be formed as described above. Among antiglare layer-forming coating liquids, for example, an irregular undercoat layer-forming coating liquid is first used to form the irregular undercoat layer similarly to the case of the monolayer, and a surface profile control layer-forming coating liquid is then used to form the surface profile control layer similarly to the case of the monolayer.

The antiglare layer formed as described above preferably has an average thickness of 1 to 25 μm, more preferably of 2 to 20 μm, particularly preferably of 3 to 15 μm. If it has a thickness of less than 1 μm, the indentation strength (pencil hardness) can be significantly reduced. If it has a thickness of more than 25 μm, it can significantly curl depending on how the binder hardens and shrinks, which is unfavorable for handleability or workability. When the antiglare layer is composed of two or more layers, the average thickness refers to the total thickness from the coated surface of the substrate to the uppermost surface with irregularities. The thickness of the antiglare layer may be measured by cross-sectional observation with a laser microscope, SEM or TEM. For example, a method for measuring the thickness with a laser microscope may include performing transmission observation of the cross-section of the antiglare layer with a confocal laser microscope (Leica TCS-NT manufactured by Leica, at 200-fold to 1000-fold magnification). Specifically, in order to form a clear image with no halation, a wet object lens is used in the confocal laser microscope, and an about 2 ml of oil with a refractive index of 1.518 is placed on the cross-section of the antiglare layer to purge the air layer between the object lens and the cross-section of the antiglare layer, when observation is performed. The thickness of the film is then measured at two points, a maximum point and a minimum point, with respect to the irregularities, per microscope observation image. The average of the measurements at ten points of five images is calculated so that the average thickness may be determined. In the SEM or TEM sectional observation, five images may also be observed when the average is determined.

Among the total thickness, the thickness of the surface profile control layer (after curing) is preferably from 0.6 μm to 20 μm and more preferably has a lower limit of 3 μm or more and an upper limit of 12 μm or less. The thickness of the surface profile control layer may be a value determined by a process that includes measuring the thickness (B) of the antiglare layer (a laminate of the irregular undercoat layer and the surface profile control layer) by cross-sectional observation with a laser microscope, SEM or TEM, then measuring the thickness (A) of the irregular undercoat layer, and subtracting A from B. If the thickness is less than 0.6 μm, improvements for glossy black feeling cannot be produced in some cases, although good antiglare properties can be provided. If the thickness is more than 20 μm, antiglare properties cannot be improved in some cases, although a very high level of glossy black feeling can be provided.

[Physical Properties of the Antiglare Layer]

In an embodiment of the invention, the antiglare layer of the antistatic antiglare film can have a surface resistivity of 1.0×10¹³ Ω/square or less, which is sufficient for preventing the attachment of dust. In the range of 1.0×10¹³ Ω/square to 1.0×10¹² Ω/square, the film may be electrified, but static charges do not build up so that the film can have dust attachment resistance. Static charges can be quickly attenuated preferably in the range of 1.0×10¹² Ω/square to 1.0×10¹⁰ Ω/square, and more preferably, no static charge is generated in the range of 1.0×10⁹ Ω/square to 1.0×10⁸ Ω/square.

Concerning the transparency, the antiglare layer according to the invention preferably has a haze of 10% to 70% according to JIS K 7105 (1981) (methods for examining optical properties of plastics). The antiglare layer more preferably has a haze of 20% to 60%, still more preferably of 30% to 50%. If the haze is less than 10%, antiglare properties or inner scattering properties can be insufficiently provided. If the haze is more than 70%, the film can become entirely whitish so that displayed images can undesirably get fuzzy.

In addition, the antiglare layer according to the invention preferably has a haze difference of 20% or less, more preferably of 10% or less, still more preferably of 5% or less, particularly preferably 3 to 1% or less, according to JIS K 7105 (1981), between before and after it is allowed to stand in a high-temperature, high-humidity chamber at a temperature of 80° C. and a humidity of 90% for 500 hours, so that it can remain transparent even after a long time of use, particularly even after a long time of use at high temperature or high humidity.

The antiglare layer according to the invention preferably has a hardness of H or higher, more preferably of 2H or higher, most preferably of 3H or higher, in the pencil hardness test according to JIS K 5400. In the taper test according to JIS K 5400, the amount of wear of the test piece is preferably as small as possible after the test.

<Low-Refractive-Index Layer>

In an embodiment of the invention, as shown in FIG. 2, the antistatic antiglare film may further include a low-refractive-index layer 4 that is placed on the antiglare layer 3 and has a refractive index lower than that of the antiglare layer 3. In an embodiment of the invention, the low-refractive-index layer preferably has a refractive index of 1.30 to 1.50, more preferably of 1.30 to 1.45. The smaller the refractive index, preferably the lower the reflectance. However, a refractive index of less than 1.30 is not preferred, because in that case, the strength of the low-refractive-index layer can be insufficient so that the antiglare film can be unfavorable for the outermost surface.

In addition, the low-refractive-index layer preferably satisfies the mathematical formula (I):

(m/4)λ×0.7<n₁d₁<(m/4)λ×1.3,

wherein m is a positive odd number, n₁ is the refractive index of the low-refractive-index layer, d₁ is the thickness (nm) of the low-refractive-index layer, λ is a wavelength in the range of 380 to 680 nm, in terms of reducing the reflectance.

Satisfying the mathematical formula (I) means that m (a positive odd number, generally 1) exists in the wavelength range.

In the invention, the low-refractive-index layer may be made of any material. For example, the low-refractive-index layer may comprise any of (1) a mixture of a resin and low-refractive-index fine particles such as silica or magnesium fluoride fine particles, (2) a fluorine-containing resin which is a low-refractive-index resin, (3) a mixture of a fluorine-containing resin and low-refractive-index fine particles such as silica or magnesium fluoride fine particles, and (4) a silica or magnesium fluoride thin film.

As used herein, the term “fluorine-containing resin” is intended to include a polymerizable compound containing at least a fluorine atom in its molecule, and a polymer of the polymerizable compound. For example, the polymerizable compound is preferably, but not limited to, a compound having a curable group such as a functional group curable by ionizing radiation (an ionizing radiation-curable group) and a polar group curable by heat (a heat-curable polar group). A compound having these reactive groups at the same time may also be used.

Examples of useful polymerizable compounds having a fluorine atom-containing, ionizing radiation-curable group include a wide variety of fluorine-containing monomers having an ethylenic unsaturated bond. Specific examples thereof include fluoroolefins (such as fluoroethylene, vinylidene fluoride, tetrafluoroethylene, hexafluoropropylene, perfluorobutadiene, and perfluoro-2,2-dimethyl-1,3-dioxole). Examples thereof also include (meth)acryloyloxy group-containing compounds such as (meth)acrylate compounds having a fluorine atom in their molecule such as 2,2,2-trifluoroethyl (meth)acrylate, 2,2,3,3,3-pentafluoropropyl (meth)acrylate, 2-(perfluorobutyl)ethyl (meth)acrylate, 2-(perfluorohexyl)ethyl (meth)acrylate, 2-(perfluorooctyl)ethyl (meth)acrylate, 2-(perfluorodecyl)ethyl (meth)acrylate, methyl α-trifluoromethacrylate, and ethyl α-trifluoromethacrylate; and fluorine-containing polyfunctional (meth)acrylate ester compounds having a C₁ to C₁₄ fluoroalkyl, fluorocycloalkyl or fluoroalkylene group with three or more fluorine atoms and having two or more (meth)acryloyloxy groups.

Examples of the polymerizable compound having a fluorine atom-containing, heat-curable polar group include 4-fluoroethylene-perfluoroalkyl vinyl ether copolymers; fluoroethylene-hydrocarbon vinyl ether copolymers; and fluorine-modified epoxy, polyurethane, cellulose, phenol, or polyimide resins. Examples of the heat-curable polar group preferably include hydrogen bond-forming groups such as hydroxyl, carboxyl, amino, and epoxy groups. These have not only adhesion to the coating film but also a high affinity for inorganic ultrafine particles such as silica.

Examples of the polymerizable compound (fluorine-containing resin) having both the ionizing radiation-curable group and the heat-curable polar group include partially or entirely fluorinated alkyl, alkenyl or aryl esters of acrylic or methacrylic acid, entirely or partially fluorinated vinyl ethers, entirely or partially fluorinated vinyl esters, and entirely or partially fluorinated vinyl ketones.

Examples of the polymers of the fluorine atom-containing polymerizable compound include polymers of a monomer or monomer mixture comprising at least one fluorine-containing (meth)acrylate compound of the polymerizable compound having the ionizing radiation-curable group; copolymers of at least one fluorine-containing (meth)acrylate compound and another (meth)acrylate compound having no fluorine atom in its molecule, such as methyl (meth)acrylate, ethyl (meth)acrylate, propyl (meth)acrylate, butyl (meth)acrylate, and 2-ethylhexyl (meth)acrylate; and homopolymers or copolymers of fluorine-containing monomers such as fluoroethylene, vinylidene fluoride, trifluoroethylene, chlorotrifluoroethylene, 3,3,3-trifluoropropylene, 1,1,2-trichloro-3,3,3-trifluoropropylene, and hexafluoropropylene.

Silicone-containing vinylidene fluoride copolymers produced by adding a silicone component to any of these copolymers may also be used as polymers of the polymerizable compound. Examples of such a silicone component include (poly)dimethylsiloxane, (poly)diethylsiloxane, (poly)diphenylsiloxane, (poly)methylphenylsiloxane, alkyl-modified (poly)dimethylsiloxane, azo group-containing (poly)dimethylsiloxane, dimethyl silicone, phenyl methyl silicone, alkyl/aralkyl-modified silicone, fluorosilicone, polyether-modified silicone, fatty acid ester-modified silicone, methyl hydrogen silicone, silanol group-containing silicone, alkoxy group-containing silicone, phenol group-containing silicone, methacrylic-modified silicone, acrylic-modified silicone, amino-modified silicone, carboxylic acid-modified silicone, carbinol-modified silicone, epoxy-modified silicone, mercapto-modified silicone, fluorine-modified silicone, and polyether-modified silicone. In particular, dimethylsiloxane structure-containing compounds are preferred.

Besides the above, other fluorine-containing resins may also be used such as compounds produced by a reaction of a fluorine-containing compound having at least one isocyanato group in the molecule with a compound having at least one functional group reactive with the isocyanato group, such as an amino, hydroxyl or carboxyl group; and compounds produced by a reaction of an isocyanato group-containing compound with a fluorine-containing polyol such as a fluorine-containing polyether polyol, fluorine-containing alkyl polyol, fluorine-containing polyester polyol, or fluorine-containing ε-caprolactone-modified polyol.

Above all, heat- or ionizing radiation-crosslinkable, fluorine-containing reins with a coefficient of dynamic friction of 0.05 to 0.30 and a contact angle of 90 to 120° for water are particularly preferred. Fluorine-containing curable resins that may be used also include perfluoroalkyl group-containing silane compounds (such as (heptadecafluoro-1,1,2,2-tetradecyl)triethoxysilane).

In an embodiment of the invention, the low-refractive-index layer preferably contains inorganic fine particles, because they can increase the strength and scratch resistance of the low-refractive-index layer. The amount of the inorganic fine particles in the coating is preferably from 1 mg/m² to 100 mg/m², more preferably from 5 mg/m² to 80 mg/m², still more preferably from 10 mg/m² to 60 mg/m². If it is less than 1 mg/m², the scratch resistance improving effect can be small. If it is more than 100 mg/m², fine irregularities can be formed on the surface of the low-refractive-index layer so that the appearance or reflectance can be undesirably degraded.

The inorganic fine particles contained in the low-refractive-index layer are preferably low-refractive-index fine particles, examples of which include magnesium fluoride fine particles and silica fine particles. In view of refractive index, dispersion stability and cost, silica fine particles are preferred. The average particle size of silica fine particles is preferably from 10% to 100%, more preferably from 20% to 90%, particularly preferably from 30% to 80% of the thickness of the low-refractive-index layer. Specifically, when the low-refractive-index layer has a thickness of 100 nm, the silica fine particles preferably have a particle size of 10 nm to 100 nm, more preferably of 20 nm to 90 nm, still more preferably of 30 nm to 80 nm. If the average particle size of the silica fine particles is less than 10% of the thickness of the low-refractive-index layer, the scratch resistance improving effect can be small. If it is more than 100% of the thickness, fine irregularities can be formed on the surface of the low-refractive-index layer so that the appearance or reflectance can be degraded. The silica fine particles may be crystalline or amorphous and may be monodisperse particles or aggregated particles as long as they have specific particle sizes. The shape of the fine particles is most preferably a sphere, while it may be an indefinite shape. The average particle size of the inorganic fine particles may be measured with a Coulter counter.

In the low-refractive-index layer, void-containing fine particles are particularly preferably used as the low-refractive-index fine particles. The void-containing fine particles can reduce the refractive index of the surface profile control layer, while maintaining the strength thereof. As used herein, the term “void-containing fine particles” is intended to include fine particles having a gas-filled internal structure and/or a gas-containing porous structure and having a refractive index decreased inversely proportional to the population of the gas in the fine particles as compared with the refractive index of the void-free fine particles. In an embodiment of the invention, void-containing fine particles also include fine particles capable of forming a nanoporous structure in at least part of the interior and/or the surface depending on the shape, structure or aggregation state of the fine particles or depending on the state of dispersion of the fine particles in the coating film. Using such fine particles, the refractive index of the low-refractive-index layer can be controlled to be from 1.30 to 1.45.

For example, the void-containing inorganic fine particles may be silica fine particles prepared by the method described in JP-A No. 2001-233611 or silica fine particles prepared by the production method described in JP-A No. 07-133105, 2002-79616 or 2006-106714. Void-containing silica fine particles are easy to produce and have high hardness. Therefore, the low-refractive-index layer formed with a mixture of a binder and void-containing silica fine particles can have increased layer strength and a controlled refractive index in the range of about 1.20 to about 1.45. Preferred examples of void-containing organic fine particles particularly include hollow polymer fine particles prepared by the technique disclosed in JP-A No. 2002-80503.

Examples of the fine particles capable of forming a nanoporous structure in at least part of the interior or surface of the coating include not only the silica fine particles described above but also sustained-release materials that are produced to have a large specific surface area and to allow various chemical substances to adsorb onto a packed column and a surface porous part; porous fine particles used for fixing catalysts; and a dispersion or aggregate of hollow fine particles to be incorporated into heat insulating materials or low-permittivity materials. Specific examples of such particles include commercially available products, and an aggregate of porous fine particles may be selected and used from Nipsil (trade name) and Nipgel (trade name) series manufactured by Nippon Silica Industries Co., Ltd., and fine particles that fall within a preferred particle size range according to the invention may be selected and used from Colloidal Silica UP series (trade name) having a chain structure of silica fine particles manufactured by Nissan Chemical Industries Ltd.

The average particle size of the void-containing fine particles is preferably from 5 nm to 300 nm and more preferably has a lower limit of 8 nm or more and an upper limit of 100 nm or less, still more preferably a lower limit of 10 nm or more and an upper limit of 80 nm or less. If the fine particles have an average particle size in this range, a high level of transparency can be imparted to the surface profile control layer. In an embodiment of the invention, the average particle size may be measured by dynamic light scattering. In the low-refractive-index layer, the amount of the void-containing fine particles is generally from about 0.1 to about 500 parts by mass, preferably from about 10 to about 200 parts by mass, based on 100 parts by mass of the matrix resin.

In order to impart antifouling properties, water resistance, chemical resistance, lubricity, or other properties, a known silicone or fluoride antifouling agent or lubricant or the like may be added as appropriate to the low-refractive-index layer according to the invention. The amount of the addition of any of these additives is preferably from 0.01 to 20% by mass, more preferably from 0.05 to 10% by mass, particularly preferably from 0.1 to 5% by mass, based on the total solids of the low-refractive-index layer. When heating means is used for curing, a thermal polymerization initiator is preferably added such that radicals can be generated by heating to initiate the polymerization of the polymerizable compound.

In an embodiment of the invention, the low-refractive-index layer may also be formed, similarly to the antiglare layer, by a process including the steps of preparing a low-refractive-index layer-forming coating liquid, applying the coating liquid to the antiglare layer, drying the coating, and optionally curing the coating by ionizing irradiation and/or heating.

In the process of forming the low-refractive-index layer, the viscosity of the low-refractive-index layer-forming coating liquid is preferably set in the range of 0.5 to 5 cps (at 25° C.), more preferably in the range of 0.7 to 3 cps (at 25° C.), such that good coatability can be obtained. In this range, a good antireflection film for visible light and a uniform thin film with no coating unevenness can be formed, and the resulting low-refractive-index layer can have particularly high adhesion to the substrate.

The low-refractive-index layer preferably has a thickness of 15 to 200 nm, more preferably of 30 to 150 nm.

<Saponification>

When a triacetylcellulose film is used as the transparent substrate film and when a pressure-sensitive adhesive layer or the like is provided on one side, the antistatic antiglare film of the invention may be placed on the uppermost surface of a display or may be used as a polarizing plate-protection film as described later. In such a case, for sufficient bonding, saponification is preferably carried out after the antiglare layer and then the low-refractive-index layer and so on are placed on the triacetylcellulose film to form an antistatic antiglare film. Saponification may be performed by a known method such as immersion of the film in an alkali liquid for an appropriate time period. After the immersion in the alkali liquid, the film is preferably washed with sufficient water or immersed in a dilute acid for neutralization of the alkali component such that the alkali component will not remain in the film.

The surface of the triacetylcellulose film opposite to the antiglare layer side is made hydrophilic by the saponification. The hydrophilized surface is particularly effective in increasing the adhesion to a polarizing film mainly composed of polyvinyl alcohol. The hydrophilized surface is less likely to attract dust in the air, so that dust is less likely to enter between the polarizing film and the antistatic antiglare film when they are bonded to each other. Therefore, the hydrophilized surface is effective in preventing dust-induced point defects.

The saponification is preferably performed such that the surface of the triacetylcellulose film opposite to the outermost layer side (such as the antiglare layer side or the low-refractive-index layer side) can have a contact angle of 40° or less for water. The contact angle is more preferably 30° or less, particularly preferably 20° or less.

After the antiglare layer is formed on the triacetylcellulose film as described above, for example, alkali saponification may be performed by immersing the film in an alkali solution at least once such that the back surface of the film may be saponified. However, this method may have a problem in which the antistatic antiglare film surface can also be saponified so that the surface can be slightly damaged or any remaining saponification solution can form a stain. In order to solve the problem, an alkali solution may be applied to the surface of the triacetylcellulose film opposite to the antiglare layer-receiving side, heated, and washed away with water and/or neutralized such that only the back surface of the antistatic antiglare film may be saponified, before or after the antiglare layer and so on are formed on the triacetylcellulose film.

<Applications>

The antistatic antiglare film of the invention may be further provided with a pressure-sensitive adhesive layer on one side and then attached to or placed on the front face of a display such as a liquid crystal display, a cathode ray tube (CRT) display and a plasma display panel so as to prevent reflection of external light and to make displayed images clearly visible.

A non-birefringent cellulose acylate film such as a triacetylcellulose film may be used as the transparent substrate film in the antistatic antiglare film of the invention. In this case, the antistatic antiglare film of the invention may be used as one of two protective films between which the polarizing layer of a polarizing plate is sandwiched. When the antistatic antiglare film of the invention is used as a protective film for the polarizing layer of a polarizing plate, both antistatic and antiglare functions are provided for the protective film of the polarizing plate so that the total cost of the resulting display can be reduced. The antistatic antiglare film of the invention may also be used for the uppermost layer of a polarizing plate so that the resulting polarizing plate can prevent reflection of external light and have a high level of scratch resistance and antifouling properties.

The embodiments described above are not intended to limit the scope of the invention. It will be understood that the embodiments are merely illustrative and that any subject including the same elements as those of the technical idea recited in each of Claims and providing the same effect or advantage will be encompassed in the technical scope of the invention.

### EXAMPLES

The invention is more specifically described below using some examples, which are not intended to limit the scope of the invention. In the examples, the term “part (or parts)” means part (or parts) by mass, unless otherwise stated.

### Example 1

### (1) Preparation of Antiglare Layer-Forming Composition

An antiglare layer-forming composition was prepared by mixing the following components: 100 parts of an ionizing radiation-curable resin (pentaerythritol triacrylate); 6.0 parts of a photopolymerization initiator (Irgacure 184 (trade name) manufactured by Ciba Specialty Chemicals Inc.); 1.25 parts of a thermoplastic resin (cellulose propionate); 7.5 parts of optically-transparent fine particles (melamine beads); 5 parts of a polymeric cationic antistatic agent (a quaternary ammonium salt-containing acrylic resin PQ-10 (trade name) manufactured by Soken Chemical & Engineering Co., Ltd.); 0.04 parts of a fluoride additive (FZ2191 (trade name) manufactured by Nippon Unicar Company Limited); and 140.3 parts of a solvent (toluene)

### (2) Preparation of Antistatic Antiglare Film

The antiglare layer-forming composition prepared in the section (1) was applied to an 80 μm thick triacetylcellulose (TAC) film by gravure reverse coating and dried. Thereafter, the coating was cured with a dose of 100 mJ/cm² in an ultraviolet radiation system (H bulb light source, Fusion UV Systems Japan KK) so that an antistatic antiglare film with a 6 μm thick antiglare layer was prepared.

The antiglare film was evaluated for surface resistivity and coating transparency by the methods described below. The resulting antiglare film was also allowed to stand in a high-temperature, high-humidity chamber at a temperature of 80° C. and a humidity of 90% for 500 hours. After the high-temperature, high-humidity test, the surface resistivity and the transparency of the coating were also evaluated. The results are shown in Table 1 below.

[Methods for Evaluation]

(1) Surface Resistivity

The measurement of the surface resistivity (Ω/square) was performed on the uppermost surface of the antiglare film at an applied voltage of 100 V for 10 seconds with a high resistivity meter (Hiresta UP manufactured by Mitsubishi Chemical Co., Ltd.).

(2) Transparency of the Coating

The haze of the uppermost surface of the antiglare film was measured according to JIS K 7105 (1981) “methods for examining the optical properties of plastics.”

### Example 2

### (1) Preparation of Antiglare Layer-Forming Composition

An antiglare layer-forming composition was prepared by mixing the following components: 277 parts of a polymeric cationic antistatic agent-containing binder (ASC-EX9000 (trade name) manufactured by Kyoeisha Chemical Co., Ltd., containing a quaternary ammonium salt-containing polymer, an ionizing radiation-curable resin and a photopolymerization initiator); 1.25 parts of a thermoplastic resin (cellulose propionate); 7.5 parts of optically-transparent fine particles (melamine beads); 0.04 parts of a fluoride additive (FZ2191 (trade name) manufactured by Nippon Unicar Company Limited); and 25 parts of a solvent (toluene).

### (2) Preparation of Antistatic Antiglare Film

An antistatic antiglare film was prepared using the process of Example 1, except that the antiglare layer-forming composition prepared in the section (1) was used instead. The antistatic antiglare film was measured for the surface resistivity and the minimum reflectance before and after the high-temperature, high-humidity test in the same manner as in Example 1. The results are shown in Table 1 below.

### Comparative Example 1

An antistatic agent-free antiglare layer was formed.

(1) Preparation of Antiglare Layer-Forming Composition

An antiglare layer-forming composition was prepared by mixing the following components: 100 parts of an ionizing radiation-curable resin (pentaerythritol triacrylate); 6.0 parts of a photopolymerization initiator (Irgacure 184 (trade name) manufactured by Ciba Specialty Chemicals Inc.); 1.25 parts of a thermoplastic resin (cellulose propionate); 7.5 parts of optically-transparent fine particles (melamine beads); 0.04 parts of a fluoride additive (FZ2191 (trade name) manufactured by Nippon Unicar Company Limited); and 140.3 parts of a solvent (toluene).

(2) Preparation of Antistatic Antiglare Film

An antistatic antiglare film was prepared using the process of Example 1, except that the antiglare layer-forming composition prepared in the section (1) was used instead. The antistatic antiglare film was measured for the surface resistivity and the minimum reflectance before and after the high-temperature, high-humidity test in the same manner as in Example 1. The results are shown in Table 1 below.

### Comparative Example 2

A low-molecular-weight antistatic agent-containing antiglare layer was formed.

(1) Preparation of Antiglare Layer-Forming Composition

An antiglare layer-forming composition was prepared by mixing the following components: 100 parts of an ionizing radiation-curable resin (pentaerythritol triacrylate); 6.0 parts of a photopolymerization initiator (Irgacure 184 (trade name) manufactured by Ciba Specialty Chemicals Inc.); 1.25 parts of a thermoplastic resin (cellulose propionate); 7.5 parts of optically-transparent fine particles (melamine beads); 5.0 parts of a low-molecular-weight, anionic, antistatic agent (Aqualon KH-10 (trade name), allyl group-containing polyoxyethylene alkyl ether sulfate type, manufactured by Dai-ichi Kogyo Seiyaku Co., Ltd.); 0.04 parts of a fluoride additive (FZ2191 (trade name) manufactured by Nippon Unicar Company Limited); and 140.3 parts of a solvent (toluene).

(2) Preparation of Antistatic Antiglare Film

An antistatic antiglare film was prepared using the process of Example 1, except that the antiglare layer-forming composition prepared in the section (1) was used instead. The antistatic antiglare film was measured for the surface resistivity and the minimum reflectance before and after the high-temperature, high-humidity test in the same manner as in Example 1. The results are shown in Table 1 below.

### [Table 1]

TABLE 1

| | Before High-Temperature | | After High-Temperature | |
|---|---|---|---|---|
| | High-Humidity Test | | High-Humidity Test | |
| | Surface Resistivity | Haze | Surface Resistivity | Haze |
| | (Ω/square) | (%) | (Ω/square) | (%) |
| Example 1 | 1.0 × 10⁹ | 50.6 | 1.0 × 10⁹ | 51.2 |
| Example 2 | 1.0 × 10⁹ | 50.2 | 1.0 × 10⁹ | 50.5 |
| Comparative | 1.0 × 10¹⁴ | 50.4 | 1.0 × 10¹⁴ | 50.5 |
| Example 1 | or more | | or more | |
| Comparative | 6.0 × 10¹⁰ | 50.9 | 1.0 × 10¹² | 80.9 |
| Example 2 | | | | |

<Summary of the Results>

It was found that in Examples 1 and 2 (antistatic antiglare films each with a polymeric antistatic agent), a surface resistivity of 1.0×10⁹ Ω/square or less necessary for prevention of dust attachment was achievable even after the high-temperature, high-humidity test, and the change in haze was 1% or less, which was a very low level, so that the transparency was maintainable.

In contrast, the antistatic agent-free antiglare film of Comparative Example 1 had a surface resistivity of more than 1.0×10¹⁴ Ω/square and was not antistatic, though the transparency was maintained. In the antiglare film of Comparative Example 2 using a low-molecular-weight antistatic agent, the surface resistivity and the haze significantly changed before and after the high-temperature, high-humidity test, and the transparency was particularly degraded after the high-temperature, high-humidity test.

### Example 3

An antistatic antiglare film having an antiglare layer with a multilayer structure of an irregular undercoat layer and a surface profile control layer was prepared.

(1) Preparation of Antiglare Layer-Forming Compositions

<Irregular Undercoat Layer-Forming Composition 1

A composition with a solids content of 40.5% was prepared by thoroughly mixing the components below. The composition was filtered through a polypropylene filter with a pore size of 30 μm to give an irregular undercoat layer-forming composition 1. The components: ionizing radiation-curable resins: 2.18 parts by weight of pentaerythritol triacrylate (PETA) (1.51 in refractive index), 0.98 parts by weight of dipentaerythritol hexaacrylate (DPHA) (1.51 in refractive index) and 0.31 parts by weight of poly(methyl methacrylate) (75,000 in molecular weight); 0.20 parts of a photopolymerization initiator (Irgacure 184 (trade name) manufactured by Ciba Specialty Chemicals Inc.); 0.03 parts of another photopolymerization initiator (Irgacure 907 (trade name) manufactured by Ciba Specialty Chemicals Inc.); 0.74 parts of optically-transparent fine particles (monodisperse acrylic beads with an average particle size of 9.5 μm and a refractive index of 1.535); 1.46 parts of optically-transparent fine particles (amorphous silica ink (a dispersion of amorphous silica with an average particle size of 1.5 μm in PETA, 60% in solids content (the silica component was 15% of the total solids), with a solvent of toluene)); 0.02 parts of a silicone leveling agent; 5.53 parts of a solvent (toluene); and 1.55 parts of another solvent (cyclohexanone)

<Surface Profile Control Layer-Forming Composition 1

A composition with a solids content of 45% was prepared by thoroughly mixing the components below. The composition was filtered through a polypropylene filter with a pore size of 10 μm to give a surface profile control layer-forming composition 1. The components: ionizing radiation-curable resins: 31.1 parts of polyfunctional urethane acrylate (UV1700B (trade name) manufactured by The Nippon Synthetic Chemical Industry Co., Ltd., 1.51 in refractive index) and 10.4 parts of isocyanuric acid-modified triacrylate (Aronix M315 (trade name) manufactured by Toagosei Co., Ltd.); 0.49 parts of a photo-curing initiator (Irgacure 184 (trade name) manufactured by Ciba Specialty Chemicals Inc.); 0.41 parts of another photo-curing initiator (Irgacure 907 (trade name) manufactured by Ciba Specialty Chemicals Inc.); 2.07 parts of an antifouling agent (UT-3971 manufactured by The Nippon Synthetic Chemical Industry Co., Ltd.); 2.08 parts of a polymeric cationic antistatic agent (a quaternary ammonium salt-containing polymer having a polyoxyethylene group of an ethylene oxide adduct, Nikkataibo (trade name), manufactured by Nippon Kasei Chemical Co., Ltd.); 48.76 parts of a solvent (toluene); and 5.59 parts of another solvent (cyclohexanone).

(2) Preparation of Antistatic Antiglare Film

A 100 μm thick polyethylene terephthalate film (A4300 manufactured by Toyobo Co., Ltd.) was used as a transparent substrate film. The irregular undercoat layer-forming composition 1 was applied to the film with a coating wire-wound rod (Myer's bar) #10 and dried by heating in an oven at 70° C. for 30 seconds. After the solvents were evaporated, the coating film was cured by ultraviolet irradiation with a dose of 30 mJ to form an irregular undercoat layer with a coating film thickness of about 7.3 g/m².

The surface profile control layer-forming composition 1 was then applied to the irregular undercoat layer with a coating wire-wound rod (Myer's bar) #18 and dried by heating in an oven at 70° C. for one minute. After the solvents were evaporated, the coating film was cured by ultraviolet irradiation with a dose of 80 mJ under nitrogen purge (200 ppm or less in oxygen concentration) to form a surface profile control layer thereon so that an antistatic antiglare film was obtained. The total thickness of the antiglare layer was about 16 μm.

### Example 4

An antistatic antiglare film having an antiglare layer with a multilayer structure of an irregular undercoat layer and a surface profile control layer was prepared.

(1) Preparation of Antiglare Layer-Forming Compositions

<Irregular Undercoat Layer-Forming Composition 2>

A liquid dispersion of amorphous silica in a resin (PETA) (2.5 μm in average particle size, 60% in solids content (the silica component was 15% of the total solids), with a solvent of toluene) and an ultraviolet-curable resin (pentaerythritol triacrylate (PETA) 1.51 in refractive index) were used to form a composition containing 20 parts by mass of optically-transparent fine particles of monodisperse acrylic beads (7.0 μm in particle size, 1.53 in refractive index), 2.5 parts by mass of monodisperse styrene beads (3.5 μm in particle size, 1.60 in refractive index) and 2.0 parts by mass of the amorphous silica, based on 100 parts by mass of the total amount of PETA with respect to the total solids. Based on 100 parts by mass of the total amount of PETA, 0.04% of a silicone leveling agent was further added, and toluene and cyclohexanone were added as appropriate and sufficiently mixed such that the final composition had a solids content of 40.5 wt % and that the ratio of toluene/cyclohexanone was set at 8/2. The resulting composition was filtered through a polypropylene filter with a pore size of 30 μm to give an irregular undercoat layer-forming composition 2.

<Surface Profile Control Layer-Forming Composition 2

A composition with a solids content of 45% was prepared by thoroughly mixing the components below. The composition was filtered through a polypropylene filter with a pore size of 10 μm to give a surface profile control layer-forming composition 2. The components: 26.01 parts by mass of colloidal silica slurry (a dispersion in methyl isobutyl ketone, 40% in solids content, 20 nm in average particle size); ionizing radiation-curable resins: 23.20 parts of polyfunctional urethane acrylate (UV1700B (trade name) manufactured by The Nippon Synthetic Chemical Industry Co., Ltd., 1.51 in refractive index) and 7.73 parts of isocyanuric acid-modified triacrylate (Aronix M315 (trade name) manufactured by Toagosei Co., Ltd.); 1.86 parts of a photo-curing initiator (Irgacure 184 (trade name) manufactured by Ciba Specialty Chemicals Inc.); 0.31 parts of another photo-curing initiator (Irgacure 907 (trade name) manufactured by Ciba Specialty Chemicals Inc.); 1.55 parts of an antifouling agent (UT-3971, a MIBK solution with a solids content of 30%, manufactured by The Nippon Synthetic Chemical Industry Co., Ltd.); 2.07 parts of a polymeric cationic antistatic agent (a quaternary ammonium salt-containing acrylic resin PQ-10 (trade name) manufactured by Soken Chemical & Engineering Co., Ltd.); 19.86 parts of a solvent (toluene); 15.56 parts of another solvent (methyl isobutyl ketone); and 3.94 parts of a further solvent (cyclohexanone).

(2) Preparation of Antistatic Antiglare Film

An 80 μm thick triacetylcellulose film (TD80U manufactured by Fuji Photo Film Co., Ltd.) was used as a transparent substrate film. The irregular undercoat layer-forming composition 2 was applied to the film with a coating wire-wound rod (Myer's bar) #8 and dried by heating in an oven at 70° C. for one minute. After the solvents were evaporated, the coating film was cured by ultraviolet irradiation with a dose of 30 mJ to form an irregular undercoat layer with a coating film thickness of 6 g/m². In the irregular undercoat layer, there was a difference of up to 0.09 between the refractive indices of the binder resin and the fine particles used, so that an internal diffusion effect was produced to prevent glare more effectively.

The surface profile control layer-forming composition 2 was then applied to the irregular undercoat layer with a coating wire-wound rod (Myer's bar) #12 and dried by heating in an oven at 70° C. for one minute. After the solvents were evaporated, the coating film was cured by ultraviolet irradiation with a dose of 100 mJ under nitrogen purge (200 ppm or less in oxygen concentration) to form a surface profile control layer thereon so that an antistatic antiglare film was obtained. The total thickness of the antiglare layer was about 11 μm.

### Example 5

An antistatic antiglare film having an antiglare layer with a multilayer structure of an irregular undercoat layer and a surface profile control layer and having a low-refractive-index layer was prepared.

(1) Preparation of Antistatic Antiglare Film

An antistatic antiglare film was prepared using the process of Example 4.

(2) Preparation of Low-Refractive-Index Layer-Forming Composition A

A composition with a solids content of 4% was prepared by thoroughly mixing the components below. The composition was filtered through a polypropylene filter with a pore size of 10 μm to give a low-refractive-index layer-forming composition A. This had a refractive index of 1.40. The components: 9.57 parts by mass of hollow silica slurry (a dispersion in isopropanol and methyl isobutyl ketone, 20% in solids content, 50 nm in particle size); 0.981 parts by mass of an ionizing radiation-curable resin (pentaerythritol triacrylate); 6.53 parts by mass of a fluoropolymer (AR110 (trade name), a methyl isobutyl ketone solution with a solids content of 15%, manufactured by Daikin Industries, Ltd.); 0.069 parts by mass of a photo-curing initiator (Irgacure 184 (trade name) manufactured by Ciba Specialty Chemicals Inc.); 0.157 parts by mass of a silicone leveling agent; 28.8 parts by mass of a solvent (propylene glycol monomethyl ether); and 53.9 parts by mass of another solvent (methyl isobutyl ketone).

(3) Preparation of Low-Refractive-Index, Antistatic, Antiglare Film

The low-refractive-index layer-forming composition was applied to the resulting antistatic antiglare film with a coating wire-wound rod (Myer's bar) #2 and dried by heating in an oven at 70° C. for one minute. After the solvents were evaporated, the coating film was cured by ultraviolet irradiation with a dose of 100 mJ under nitrogen purge (200 ppm or less in oxygen concentration) to form an about 100 nm thick low-refractive-index layer thereon, so that a low-refractive-index, antistatic, antiglare film was obtained.

### [Table 2]

TABLE 2

| | Before High-Temperature | | After High-Temperature | |
|---|---|---|---|---|
| | High-Humidity Test | | High-Humidity Test | |
| | Surface Resistivity | Haze | Surface Resistivity | Haze |
| | (Ω/square) | (%) | (Ω/square) | (%) |
| Example 3 | 2.0 × 10⁹ | 0.8 | 2.0 × 10⁹ | 0.9 |
| Example 4 | 1.5 × 10⁹ | 5.9 | 1.5 × 10⁹ | 6.2 |
| Example 5 | 1.4 × 10⁹ | 5.2 | 1.5 × 10⁹ | 5.8 |

The antistatic antiglare film having the surface profile control layer-containing composite antiglare layer in each of Examples 3 to 5 was measured for surface profile. Sm, θa and Rz were measured with a surface roughness meter (Model No. SE-3400 manufactured by Kosaka Laboratory Ltd.) according to JIS B 0601 (1994) under the following conditions: (1) probe needle of surface roughness detection part, Model No. SE2555N (2 μm standard) manufactured by Kosaka Laboratory Ltd., 2 μm in tip curvature radius, 90 degrees in apex angle, made of diamond; and (2) surface roughness meter measurement conditions of a reference length of 0.8 mm (the cut-off value λc of the roughness curve), an evaluation length of 4.0 mm (5 times the reference length (the cut-off value λc) and a probe needle feed speed of 0.1 mm/second. The results are shown in Table 3.

### [Table 3]

TABLE 3

| | θa (°) | Sm (μm) | Rz (μm) |
|---|---|---|---|
| Example 3 | 0.37 | 176.7 | 0.69 |
| Example 4 | 0.70 | 83.5 | 0.41 |
| Example 5 | 0.64 | 90.7 | 0.30 |

The definition of each parameter and the measurement method and conditions are according to JIS B 0601 (1994).

<Summary of the Results>

It was found that in Examples 3 and 4 (antistatic antiglare films each having a surface profile control layer-containing composite antiglare layer with a polymeric antistatic agent), a surface resistivity of 2.0×10⁹ Ω/square or less necessary for prevention of dust deposition was achievable even after the high-temperature, high-humidity test, and the change in haze was 1.0% or less, which was a very low level, so that the transparency was maintainable. The antistatic antiglare films each having a surface profile control layer-containing composite antiglare layer with a polymeric antistatic agent had a high level of reproducibility of natural black.

1. An antistatic antiglare film, comprising:
a transparent substrate film; and
an antiglare layer that is disposed on the transparent substrate film and comprises a polymeric antistatic agent, optically-transparent fine particles and a binder.

2. The antistatic antiglare film according to claim 1, wherein the polymeric antistatic agent is a polymeric quaternary ammonium salt.

3. The antistatic antiglare film according to claim 2, wherein the polymeric quaternary ammonium salt is a polymer comprising 1 to 70% by mole of a quaternary ammonium salt-containing repeating unit.

4. The antistatic antiglare film according to claim 1, wherein the antiglare layer has a surface resistivity of 10¹³ Ω/square or less.

5. The antistatic antiglare film according to claim 1, wherein the antistatic antiglare film has a haze difference of 20% or less according to JIS K 7105 (1981) between before and after it is allowed to stand in a high-temperature, high-humidity chamber at a temperature of 80° C. and a humidity of 90% for 500 hours.

6. The antistatic antiglare film according to claim 1, further comprising a low-refractive-index layer that is placed on the antiglare layer and has a refractive index lower than that of the antiglare layer.
